(19) United States
(12) Patent Application Publication
(10) Pub. No.: US 2015/0326045 A1
(43) Pub. Date: Nov. 12, 2015

(54) APPARATUS FOR CHARGING WEARABLE DEVICE

(71) Applicant: Samsung Electronics Co., Ltd., Suwon-si (KR)

(72) Inventors: Jongmin CHOI, Seongnam-si (KR); Kwangjin BAE, Suwon-si (KR); Hongmoon CHUN, Yongin-si (KR)

(21) Appl. No.: 14/706,352

(22) Filed: May 7, 2015

(30) Foreign Application Priority Data
May 9, 2014 (KR) 10-2014-0055826

(51) Int. Cl. H02J 7/00

(52) U.S. Cl. CPC H02J 7/0044

(57) ABSTRACT

A charging apparatus is provided. The charging apparatus includes a cradle and a charger module. The cradle includes a space for holding an electronic device, and includes at least one magnetic member for providing a magnetic connection with the electronic device. The charger module is connected with the cradle and supplies electric power to the electronic device.

### CROSS-REFERENCE TO RELATED APPLICATION(S)

This application claims the benefit under 35 U.S.C. §119(a) of a Korean patent application filed on May 9, 2014 in the Korean Intellectual Property Office and assigned Serial number 10-2014-0055826, the entire disclosure of which is hereby incorporated by reference.

### TECHNICAL FIELD

The present disclosure relates to an apparatus for charging a wearable device.

### BACKGROUND

With mobile electronic devices advancing dramatically, wearable devices are now getting the spotlight in the market. Such a wearable device can be mounted on a user's body (e.g., a wrist), thus enhancing portability and accessibility in use.

The above information is presented as background information only to assist with an understanding of the present disclosure. No determination has been made, and no assertion is made, as to whether any of the above might be applicable as prior art with regard to the present disclosure.

### SUMMARY

Aspects of the present disclosure are to address at least the above-mentioned problems and/or disadvantages and to provide at least the advantages described below. Accordingly, an aspect of the present disclosure is to provide an apparatus for easily and effectively charging a wearable device having various functions.

In accordance with an aspect of the present disclosure, a charging apparatus is provided. The charging apparatus includes a cradle including a space for holding an electronic device, and including at least one magnetic member for providing a magnetic connection with the electronic device, and a charger module connected with the cradle and supplying electric power to the electronic device.

In accordance with another aspect of the present disclosure, a cradle is provided. The cradle includes a space for holding an electronic device, and at least one magnetic member for providing a magnetic connection with the electronic device.

Other aspects, advantages, and salient features of the disclosure will become apparent to those skilled in the art from the following detailed description, which, taken in conjunction with the annexed drawings, discloses various embodiments of the present disclosure.

### BRIEF DESCRIPTION OF THE DRAWINGS

The above and other aspects, features, and advantages of certain embodiments of the present disclosure will be more apparent from the following description taken in conjunction with the accompanying drawings, in which:

FIG. 1 is a block diagram illustrating a network environment including therein an electronic device according to various embodiments of the present disclosure;

FIG. 2 is a block diagram illustrating an electronic device according to various embodiments of the present disclosure;

FIG. 3 is an exploded perspective view illustrating a charger module according to various embodiments of the present disclosure;

FIG. 4 is a perspective view illustrating a charger module according to various embodiments of the present disclosure;

FIG. 5 is an exploded perspective view illustrating an assembly-type charging apparatus according to various embodiments of the present disclosure;

FIG. 6 is a perspective view illustrating an assembly-type charging apparatus according to various embodiments of the present disclosure;

FIG. 7 is a perspective view illustrating an assembly-type charging apparatus according to various embodiments of the present disclosure;

FIGS. 8A and 8B are plan views illustrating the disposition of magnetic members in an assembly-type charging apparatus and a wearable device according to various embodiments of the present disclosure;

FIGS. 9A and 9B are plan views illustrating the disposition of magnetic members in an assembly-type charging apparatus and a wearable device according to various embodiments of the present disclosure; and

FIGS. 10A and 10B are views illustrating a process of combining a wearable device with an assembly-type charging apparatus according to various embodiments of the present disclosure.

Throughout the drawings, it should be noted that like reference numbers are used to depict the same or similar elements, features, and structures.

### DETAILED DESCRIPTION

The following description with reference to the accompanying drawings is provided to assist in a comprehensive understanding of various embodiments of the present disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope and spirit of the present disclosure. In addition, descriptions of well-known functions and constructions may be omitted for clarity and conciseness.

The terms and words used in the following description and claims are not limited to the bibliographical meanings, but, are merely used by the inventor to enable a clear and consistent understanding of the present disclosure. Accordingly, it should be apparent to those skilled in the art that the following description of various embodiments of the present disclosure is provided for illustration purpose only and not for the purpose of limiting the present disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

According to various embodiments, a charging apparatus may include a cradle for holding different wearable devices, and a charger module. Wearable devices may be, for example, Galaxy Gear, Galaxy Gear 2, Galaxy Fit, or any other wearable device.

In various embodiments, a wearable device may include therein at least one magnetic member to be combined with that in a cradle of a charging apparatus. This wearable device may execute a great variety of functions or applications.

As used herein, “Or” means “and/or”. As used herein, the term “and/or” includes any and all combinations of one or more of the associated listed items. It will be further understood that the terms “comprises” and/or “comprising”, or “includes” and/or “including” when used in this specification, specify the presence of stated features, regions, integers, steps, operations, elements, and/or components, but do not preclude the presence or addition of one or more other features, regions, integers, steps, operations, elements, components, and/or groups thereof.

It will be understood that, although the terms “first”, “second”, “third”, etc. may be used herein to describe various elements, components, regions, layers and/or sections, these elements, components, regions, layers and/or sections should not be limited by these terms. These terms are only used to distinguish one element, component, region, layer or section from another element, component, region, layer or section. Thus, “a first element”, “component”, “region”, “layer” or “section” discussed below could be termed a second element, component, region, layer or section without departing from the teachings herein.

In this disclosure, an electronic device may be a device that involves a communication function. For example, an electronic device may be a smart phone, a tablet Personal Computer (PC), a mobile phone, a video phone, an e-book reader, a desktop PC, a laptop PC, a netbook computer, a Personal Digital Assistant (PDA), a Portable Multimedia Player (PMP), a digital audio player, a portable medical device, a digital camera, or a wearable device (e.g., an Head-Mounted Device (HMD) such as electronic glasses, electronic clothes, an electronic bracelet, an electronic necklace, an electronic appcessory, or a smart watch).

According to some embodiments, an electronic device may be a smart home appliance that involves a communication function. For example, an electronic device may be a television (TV), a Digital Video Disc (DVD) player, audio equipment, a refrigerator, an air conditioner, a vacuum cleaner, an oven, a microwave, a washing machine, an air cleaner, a set-top box, a TV box (e.g., Samsung HomeSync™, Apple TV™, Google TV™, etc.), a game console, an electronic dictionary, an electronic key, a camcorder, or an electronic picture frame.

According to some embodiments, an electronic device may be a medical device (e.g., Magnetic Resonance Angiography (MRA), Magnetic Resonance Imaging (MRI), Computed Tomography (CT), ultrasonography, etc.), a navigation device, a Global Positioning System (GPS) receiver, an Event Data Recorder (EDR), an Flight Data Recorder (FDR), a car infotainment device, electronic equipment for ship (e.g., a marine navigation system, a gyrocompass, etc.), avionics, security equipment, or an industrial or home robot.

According to some embodiments, an electronic device may be furniture or part of a building or construction having a communication function, an electronic board, an electronic signature receiving device, a projector, or various measuring instruments (e.g., a water meter, an electric meter, a gas meter, a wave meter, etc.). An electronic device disclosed herein may be one of the above-mentioned devices or any combination thereof. As well understood by those skilled in the art, the above-mentioned electronic devices are exemplary only and not to be considered as a limitation of this disclosure.

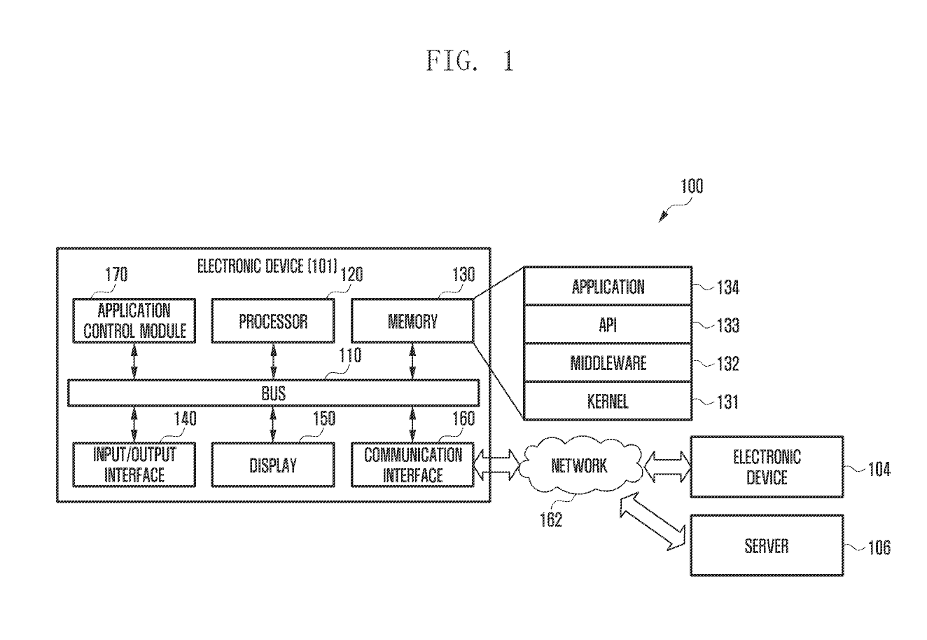

FIG. 1 is a block diagram illustrating a network environment 100 including therein an electronic device 101 according to an embodiment of the present disclosure.

Referring to FIG. 1, the electronic device 101 may include, but not limited to, a bus 110, a processor 120, a memory 130, an input/output interface 140, a display 150, a communication interface 160, and an application control module 170.

The bus 110 may be a circuit designed for connecting the above-discussed elements and communicating data (e.g., a control message) between such elements.

The processor 120 may receive commands from the other elements (e.g., the memory 130, the input/output interface 140, the display 150, the communication interface 160, or the application control module 170, etc.) through the bus 110, interpret the received commands, and perform the arithmetic or data processing based on the interpreted commands.

The memory 130 may store therein commands or data received from or created at the processor 120 or other elements (e.g., the input/output interface 140, the display 150, the communication interface 160, or the application control module 170, etc.). The memory 130 may include programming modules such as a kernel 131, a middleware 132, an application programming interface (API) 133, and an application 134. Each of the programming modules may be composed of software, firmware, hardware, and any combination thereof.

The kernel 131 may control or manage system resources (e.g., the bus 110, the processor 120, or the memory 130, etc.) used for performing operations or functions of the other programming modules, e.g., the middleware 132, the API 133, or the application 134. Additionally, the kernel 131 may offer an interface that allows the middleware 132, the API 133 or the application 134 to access, control or manage individual elements of the electronic device 101.

The middleware 132 may perform intermediation by which the API 133 or the application 134 communicates with the kernel 131 to transmit or receive data. Additionally, in connection with task requests received from the applications 134, the middleware 132 may perform a control (e.g., scheduling or load balancing) for the task request by using technique such as assigning the priority for using a system resource of the electronic device 101 (e.g., the bus 110, the processor 120, or the memory 130, etc.) to one or more of the application 134.

The API 133 which is an interface for allowing the application 134 to control a function provided by the kernel 131 or the middleware 132 may include, for example, at least one interface or function (e.g., a command) for a file control, a window control, an image processing, a text control, and the like.

According to embodiments, the application 134 may include an short message service (SMS)/multimedia message service (MMS) application, an email application, a calendar application, an alarm application, a health care application (e.g., an application for measuring quantity of motion or blood sugar), an environment information application (e.g., an application for offering information about atmospheric pressure, humidity, or temperature, etc.), and the like. Additionally or alternatively, the application 134 may be an application associated with an exchange of information between the electronic device 101 and any external electronic device (e.g., an external electronic device 104). This type application may include a notification relay application for delivering specific information to an external electronic device, or a device management application for managing an external electronic device.

For example, the notification relay application may include a function to deliver notification information created at any other application of the electronic device 101 (e.g., the SMS/MMS application, the email application, the health care application, or the environment information application, etc.) to an external electronic device (e.g., the electronic device 104). Additionally or alternatively, the notification relay application may receive notification information from an external electronic device (e.g., the electronic device 104) and offer it to a user. The device management application may manage (e.g., install, remove or update) a certain function (a turn-on/turn-off of an external electronic device (or some components thereof), or an adjustment of brightness (or resolution) of a display) of any external electronic device (e.g., the electronic device 104) communicating with the electronic device 101, a certain application operating at such an external electronic device, or a certain service (e.g., a call service or a message service) offered by such an external electronic device.

According to embodiments, the application 134 may include a specific application specified depending on attributes (e.g., a type) of an external electronic device (e.g., the electronic device 104). For example, in case an external electronic device is an MP3 player, the application 134 may include a specific application associated with a play of music. Similarly, in case an external electronic device is a portable medical device, the application 134 may include a specific application associated with a health care. In an embodiment, the application 134 may include at least one of an application assigned to the electronic device 101 or an application received from an external electronic device (e.g., the server 106 or the electronic device 104).

The input/output interface 140 may deliver commands or data, entered by a user through an input/output unit (e.g., a sensor, a keyboard, or a touch screen), to the processor 120, the memory 130, the communication interface 160, or the application control module 170 via the bus 110. For example, the input/output interface 140 may offer data about a user's touch, entered through the touch screen, to the processor 120. Also, through the input/output unit (e.g., a speaker or a display), the input/output interface 140 may output commands or data, received from the processor 120, the memory 130, the communication interface 160, or the application control module 170 via the bus 110. For example, the input/output interface 140 may output voice data, processed through the processor 120, to a user through the speaker.

The display 150 may display thereon various kinds of information (e.g., multimedia data, text data, etc.) to a user.

The communication interface 160 may perform a communication between the electronic device 101 and any external electronic device (e.g., the electronic device 104 of the server 106). For example, the communication interface 160 may communicate with any external device by being connected with a network 162 through a wired or wireless communication. A wireless communication may include, but not limited to, at least one of Wireless Fidelity (WiFi), Bluetooth (BT), Near Field Communication (NFC), Global Positioning System (GPS), or a cellular communication (e.g., long term evolution (LTE), LTE advanced (LTE-A), code division multiple access (CDMA), wireless CDMA (WCDMA), universal mobile telecommunications system (UMTS), wireless broadband (WiBro), or global system for mobile (GSM), etc.). A wired communication may include, but not limited to, at least one of Universal Serial Bus (USB), High Definition Multimedia Interface (HDMI), Recommended Standard 232 (RS 232), or Plain Old Telephone Service (POTS).

According to an embodiment, the network 162 may be a communication network, which may include at least one of a computer network, an internet, an internet of things, or a telephone network. According to an embodiment, a protocol (e.g., transport layer protocol, data link layer protocol, or physical layer protocol) for a communication between the electronic device 101 and any external device may be supported by at least one of the application 134, the API 133, the middleware 132, the kernel 131, or the communication interface 160.

The application control module 170 may process at least part of information obtained from the other elements (e.g., the processor 120, the memory 130, the input/output interface 140, or the communication interface 160, etc.) and then offer it to a user in various ways. For example, the application control module 170 may recognize information about access components equipped in the electronic device 101, store such information in the memory 130, and execute the application 134 on the basis of such information.

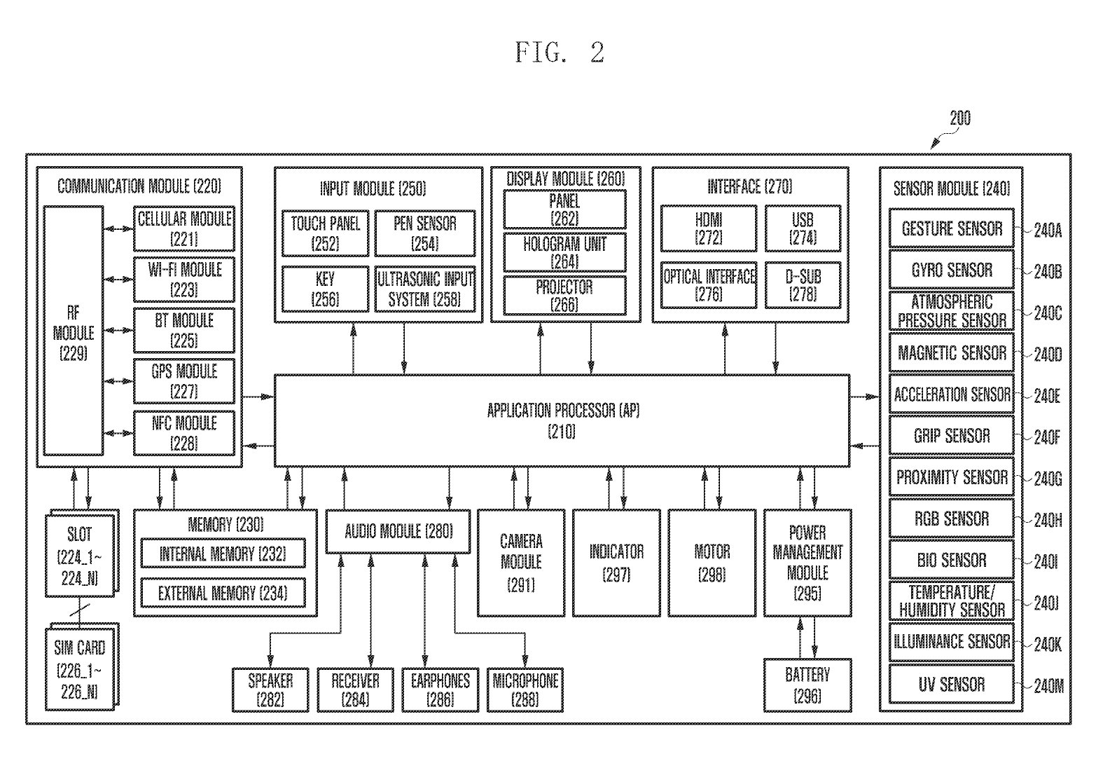

FIG. 2 is a block diagram illustrating an electronic device 201 according to an embodiment of the present disclosure. The electronic device 201 may form, for example, the whole or part of the electronic device 101 shown in FIG. 1.

Referring to FIG. 2, the electronic device 201 may include at least one application processor (AP) 210, a communication module 220, one or more of subscriber identification module (SIM) cards 226_1 to 226_N, a memory 230, a sensor module 240, an input module 250, a display module 260, an interface 270, an audio module 280, a camera module 291, a power management module 295, a battery 296, an indicator 297, and a motor 298.

The AP 210 may drive an operating system or applications, control a plurality of hardware or software components connected thereto, and also perform processing and operation for various data including multimedia data. The AP 210 may be formed of system-on-chip (SoC), for example. According to an embodiment, the AP 210 may further include a graphic processing unit (GPU) (not shown).

The communication module 220 (e.g., the communication interface 160) may perform a data communication with any other electronic device (e.g., the electronic device 104 or the server 106) connected to the electronic device 200 (e.g., the electronic device 101) through the network. According to an embodiment, the communication module 220 may include therein a cellular module 221, a WiFi module 223, a BT module 225, a GPS module 227, an NFC module 228, and a Radio Frequency (RF) module 229.

The cellular module 221 may offer a voice call, a video call, a message service, an interne service, or the like through a communication network (e.g., LTE, LTE-A, CDMA, WCDMA, UMTS, WiBro, or GSM, etc.). Additionally, the cellular module 221 may perform identification and authentication of the electronic device in the communication network, using one or more of the SIM cards 226_1 to 226_N. According to an embodiment, the cellular module 221 may perform at least part of functions the AP 210 can provide. For example, the cellular module 221 may perform at least part of a multimedia control function.

According to an embodiment, the cellular module 221 may include a communication processor (CP). Additionally, the cellular module 221 may be formed of SoC, for example. Although some elements such as the cellular module 221 (e.g., the CP), the memory 230, or the power management module 295 are shown as separate elements being different from the AP 210 in FIG. 2, the AP 210 may be formed to have at least part (e.g., the cellular module 221) of the above elements in an embodiment.

According to an embodiment, the AP 210 or the cellular module 221 (e.g., the CP) may load commands or data, received from a nonvolatile memory connected thereto or from at least one of the other elements, into a volatile memory to process them. Additionally, the AP 210 or the cellular module 221 may store data, received from or created at one or more of the other elements, in the nonvolatile memory.

Each of the WiFi module 223, the BT module 225, the GPS module 227 and the NFC module 228 may include a processor for processing data transmitted or received therethrough. Although FIG. 2 shows the cellular module 221, the WiFi module 223, the BT module 225, the GPS module 227 and the NFC module 228 as different blocks, at least part of them may be contained in a single Integrated Circuit (IC) chip or a single IC package in an embodiment. For example, at least part (e.g., the CP corresponding to the cellular module 221 and a WiFi processor corresponding to the WiFi module 223) of respective processors corresponding to the cellular module 221, the WiFi module 223, the BT module 225, the GPS module 227 and the NFC module 228 may be formed as a single SoC.

The RF module 229 may transmit and receive data, e.g., RF signals or any other electric signals. Although not shown, the RF module 229 may include a transceiver, a Power Amp Module (PAM), a frequency filter, a Low Noise Amplifier (LNA), or the like. Also, the RF module 229 may include any component, e.g., a wire or a conductor, for transmission of electromagnetic waves in a free air space. Although FIG. 2 shows that the cellular module 221, the WiFi module 223, the BT module 225, the GPS module 227 and the NFC module 228 share the RF module 229, at least one of them may perform transmission and reception of RF signals through a separate RF module in an embodiment.

The SIM cards 226_1 to 226_N may be a specific card formed of SIM and may be inserted into slots 224_1 to 224_N formed at a certain place of the electronic device. The SIM cards 226_1 to 226_N may contain therein an Integrated Circuit Card IDentifier (ICCID) or an International Mobile Subscriber Identity (IMSI).

The memory 230 (e.g., the memory 130) may include an internal memory 232 and an external memory 234. The internal memory 232 may include, for example, at least one of a volatile memory (e.g., Dynamic RAM (DRAM), Static RAM (SRAM), Synchronous DRAM (SDRAM), etc.) or a nonvolatile memory (e.g., One Time Programmable ROM (OTPROM), Programmable ROM (PROM), Erasable and Programmable ROM (EPROM), Electrically Erasable and Programmable ROM (EEPROM), mask ROM, flash ROM, NAND flash memory, NOR flash memory, etc.).

According to an embodiment, the internal memory 232 may have the form of a Solid State Drive (SSD). The external memory 234 may include a flash drive, e.g., Compact Flash (CF), Secure Digital (SD), Micro Secure Digital (Micro SD), Mini Secure Digital (Mini SD), eXtreme Digital (xD), memory stick, or the like. The external memory 234 may be functionally connected to the electronic device 200 through various interfaces. According to an embodiment, the electronic device 200 may further include a storage device or medium such as a hard drive.

The sensor module 240 may measure physical quantity or sense an operating status of the electronic device 200, and then convert measured or sensed information into electric signals. The sensor module 240 may include, for example, at least one of a gesture sensor 240A, a gyro sensor 240B, an atmospheric sensor 240C, a magnetic sensor 240D, an acceleration sensor 240E, a grip sensor 240F, a proximity sensor 240G, a color sensor 240H (e.g., Red, Green, Blue (RGB) sensor), a biometric sensor 240I, a temperature-humidity sensor 240J, an illumination sensor 240K, and a ultraviolet (UV) sensor 240M. Additionally or alternatively, the sensor module 240 may include, e.g., an E-nose sensor (not shown), an electromyography (EMG) sensor (not shown), an electroencephalogram (EEG) sensor (not shown), an electrocardiogram (ECG) sensor (not shown), an infrared (IR) sensor (not shown), an iris scan sensor (not shown), or a finger scan sensor (not shown). Also, the sensor module 240 may include a control circuit for controlling one or more sensors equipped therein.

The input module 250 may include a touch panel 252, a digital pen sensor 254, a key 256, or an ultrasonic input unit 258. The touch panel 252 may recognize a touch input in a manner of capacitive type, resistive type, infrared type, or ultrasonic type. Also, the touch panel 252 may further include a control circuit. In case of a capacitive type, a physical contact or proximity may be recognized. The touch panel 252 may further include a tactile layer. In this case, the touch panel 252 may offer a tactile feedback to a user.

The digital pen sensor 254 may be formed in the same or similar manner as receiving a touch input or by using a separate recognition sheet. The key 256 may include, for example, a physical button, an optical key, or a keypad. The ultrasonic input unit 258 is a specific device capable of identifying data by sensing sound waves with a microphone 288 in the electronic device 200 through an input tool that generates ultrasonic signals, thus allowing wireless recognition. According to an embodiment, the electronic device 200 may receive a user input from any external device (e.g., a computer or a server) connected thereto through the communication module 220.

The display module 260 (e.g., the display 150) may include a panel 262, a hologram unit 264, or a projector 266. The panel 262 may be, for example, Liquid Crystal Display (LCD), Active Matrix Organic Light Emitting Diode (AM-OLED), or the like. The panel 262 may have a flexible, transparent or wearable form. The panel 262 may be formed of a single module with the touch panel 252. The hologram unit 264 may show a stereoscopic image in the air using interference of light. The projector 266 may project an image onto a screen, which may be located at the inside or outside of the electronic device 200. According to an embodiment, the display module 260 may further include a control circuit for controlling the panel 262, the hologram unit 264, and the projector 266.

The interface 270 may include, for example, an HDMI 272, a USB 274, an optical interface 276, or a D-subminiature (D sub) 278. The interface 270 may be contained, for example, in the communication interface 160 shown in FIG. 1. Additionally or alternatively, the interface 270 may include, for example, an Mobile High-definition Link (MHL) interface, a Secure Digital card/Multi-Media Card (MMC) interface, or an Infrared Data Association (IrDA) interface.

The audio module 280 may perform a conversion between sounds and electric signals. At least part of the audio module 280 may be contained, for example, in the input/output interface 140 shown in FIG. 1. The audio module 280 may process sound information inputted or outputted through a speaker 282, a receiver 284, an earphone 286, or a microphone 288.

The camera module 291 is a device capable of obtaining still images and moving images. According to an embodiment, the camera module 291 may include at least one image sensor (e.g., a front sensor or a rear sensor), a lens (not shown), an Image Signal Processor (ISP), not shown), or a flash (e.g., LED or xenon lamp, not shown).

The power management module 295 may manage electric power of the electronic device 200. Although not shown, the power management module 295 may include, for example, a Power Management Integrated Circuit (PMIC), a charger IC, or a battery or fuel gauge.

The PMIC may be formed, for example, of an IC chip or SoC. Charging may be performed in a wired or wireless manner. The charger IC may charge a battery 296 and prevent overvoltage or overcurrent from a charger. According to an embodiment, the charger IC may have a charger IC used for at least one of wired and wireless charging types. A wireless charging type may include, for example, a magnetic resonance type, a magnetic induction type, or an electromagnetic type. Any additional circuit for a wireless charging may be further used such as a coil loop, a resonance circuit, or a rectifier.

The battery gauge may measure the residual amount of the battery 296 and a voltage, current or temperature in a charging process. The battery 296 may store or create electric power therein and supply electric power to the electronic device 200. The battery 296 may be, for example, a rechargeable battery or a solar battery.

The indicator 297 may show thereon a current status (e.g., a booting status, a message status, or a recharging status) of the electronic device 200 or of its part (e.g., the AP 210). The motor 298 may convert an electric signal into a mechanical vibration. Although not shown, the electronic device 200 may include a specific processor (e.g., GPU) for supporting a mobile TV. This processor may process media data that comply with standards of Digital Multimedia Broadcasting (DMB), Digital Video Broadcasting (DVB), or media flow.

Each of the above-discussed elements of the electronic device disclosed herein may be formed of one or more components, and its name may be varied according to the type of the electronic device. The electronic device disclosed herein may be formed of at least one of the above-discussed elements without some elements or with additional other elements. Some of the elements may be integrated into a single entity that still performs the same functions as those of such elements before being integrated.

The term “module” used in this disclosure may refer to a certain unit that includes one of hardware, software and firmware or any combination thereof. The module may be interchangeably used with unit, logic, logical block, component, or circuit, for example. The module may be the minimum unit, or part thereof, which performs one or more particular functions. The module may be formed mechanically or electronically. For example, the module disclosed herein may include at least one of Application-Specific Integrated Circuit (ASIC) chip, Field-Programmable Gate Arrays (FPGAs), and programmable-logic device, which have been known or are to be developed.

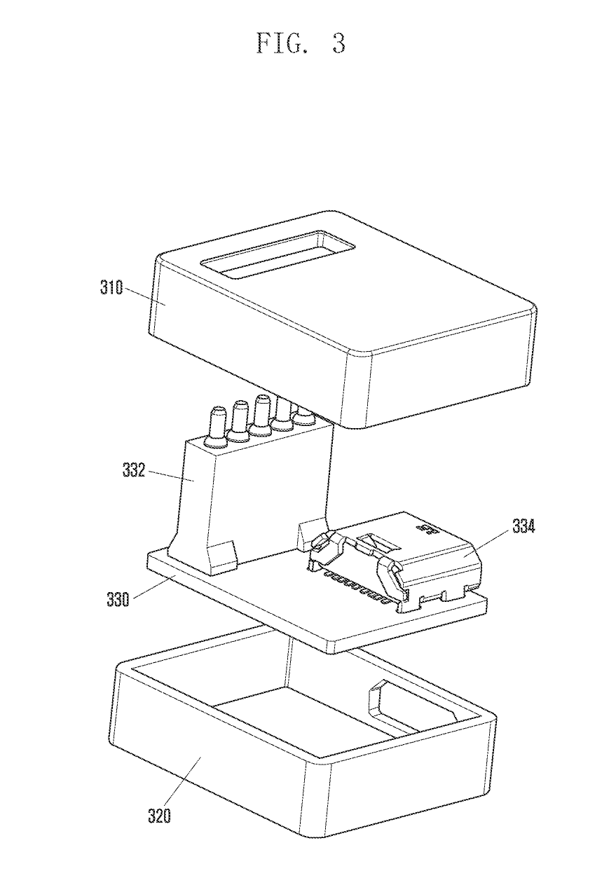

FIG. 3 is an exploded perspective view illustrating a charger module according to various embodiments of the present disclosure.

Referring to FIG. 3, the charger module may include a first housing 310, a second housing 320, a Printed Circuit Board (PCB) 330, a charging terminal 332, and an external power connecting terminal 334.

The first housing 310 may have a first hole which the charging terminal 332 is partially inserted into and pins thereof pass through. The size and shape of the first hole of the first housing 310 correspond to those of the charging terminal 332. For example, the first hole of the first housing 310 may have an elongated shape, a rectangular shape, a quadrilateral shape with round corners, or a circular shape.

The first housing 310 may include a flat part, having the first hole therein, and a peripheral part extended vertically from edges of the flat part. Therefore, the first housing 310 has an open-type structure capable of accommodating something in an internal space formed by the flat part and the peripheral part.

The first housing 310 may be formed of synthetic resin, thermoplastic polymer (e.g., Acrylonitrile Butadiene Styrene (ABS) or polycarbonate), ceramic, wood, metal (e.g., polished aluminum), metal alloy (e.g., based on steel, stainless steel, titanium or magnesium), or any other suitable material.

The second housing 320 may have a second hole which the external power connecting terminal 334 is partially inserted into and pins thereof are exposed to. The size and shape of the second hole of the second housing 320 correspond to those of the external power connecting terminal 334. For example, the second hole of the second housing 320 may have an elongated shape, a rectangular shape, a quadrilateral shape with round corners, or a circular shape.

The second housing 320 may include a flat part and a peripheral part having the second hole therein and extended vertically from edges of the flat part. Therefore, the second housing 320 has an open-type structure capable of accommodating something in an internal space formed by the flat part and the peripheral part.

The second housing 320 may be formed of synthetic resin, thermoplastic polymer (e.g., ABS or polycarbonate), ceramic, wood, metal (e.g., polished aluminum), metal alloy (e.g., based on steel, stainless steel, titanium or magnesium), or any other suitable material.

The first and second housings 310 and 320 may be combined with each other through a suitable fastening member such as hooks, screws, bonding, or the like. The combined first and second housings 310 and 320 form the outer appearance of the charger module 400 and also form an internal space in which the PCB 330, the charging terminal 332 and the external power connecting terminal 334 can be disposed.

On and in PCB 330 a variety of electric components such as integrated circuits, resistors, and switches are mounted or embedded.

In one embodiment, the charging terminal 332 and the external power connecting terminal 334 may be mounted on the PCB 330.

The charging terminal 332 may be in contact with charging pins of a wearable device and can supply electric power to the wearable device through such contact. For reliable mechanical and electrical coupling, the charging terminal 332 may have protruding pins corresponding to the charging pins of the wearable device. Namely, the position and shape of the charging pins of the wearable device correspond to the protruding pins of the charging terminal 332.

The external power connecting terminal 334 may be connected to a power connector (e.g., a cable or USB). For reliable mechanical and electrical coupling, one end of the external power connecting terminal 334 may have a specific shape corresponding to the power connector.

In one embodiment, the external power connecting terminal 334 may have a USB-type socket and receive electric power through a USB-type power connector. Alternatively, the external power connecting terminal 334 may be replaced with an integrated cable.

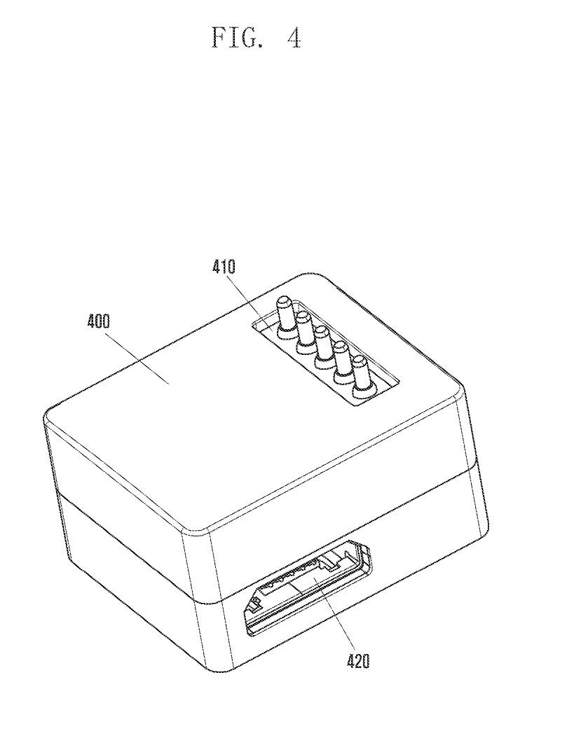

FIG. 4 is a perspective view illustrating a charger module according to various embodiments of the present disclosure.

FIG. 4 shows the charger module 400 obtained by assembling the first housing 310, the second housing 320, the PCB 330, the charging terminal 332 and the external power connecting terminal 334 shown in FIG. 3.

The charger module 400 may have a substantially cubic shape with round edges. Since a combination of the first and second housings 310 and 320 forms the outer appearance of the charger module 400, the charger module 400 may be formed of synthetic resin, thermoplastic polymer (e.g., ABS or polycarbonate), ceramic, wood, metal (e.g., polished aluminum), metal alloy (e.g., based on steel, stainless steel, titanium or magnesium), or any other suitable material.

Also, the combination of the first and second housings 310 and 320 forms the internal space of the charger module 400. In this space, the PCB 330, the charging terminal 332, the external power connecting terminal 334, and the like can be disposed and mounted.

In one embodiment, the charger module 400 may have a first hole 410 and a second hole 420. The first hole 410 may be formed on the first housing 310 and have a specific shape corresponding to that of the charging terminal 332, such as an elongated shape, a rectangular shape, a quadrilateral shape with round corners, or a circular shape.

The charging terminal 332 may be exposed to the outside through the first hole 410 and electrically connected to charging pins of the wearable device.

The second hole 420 may be formed on the second housing 320 and have a specific shape corresponding to that of the external power connecting terminal 334, such as an elongated shape, a rectangular shape, a quadrilateral shape with round corners, or a circular shape.

The external power connecting terminal 334 may be exposed to the outside through the second hole 420 and electrically connected to a power connector (e.g., a cable or USB).

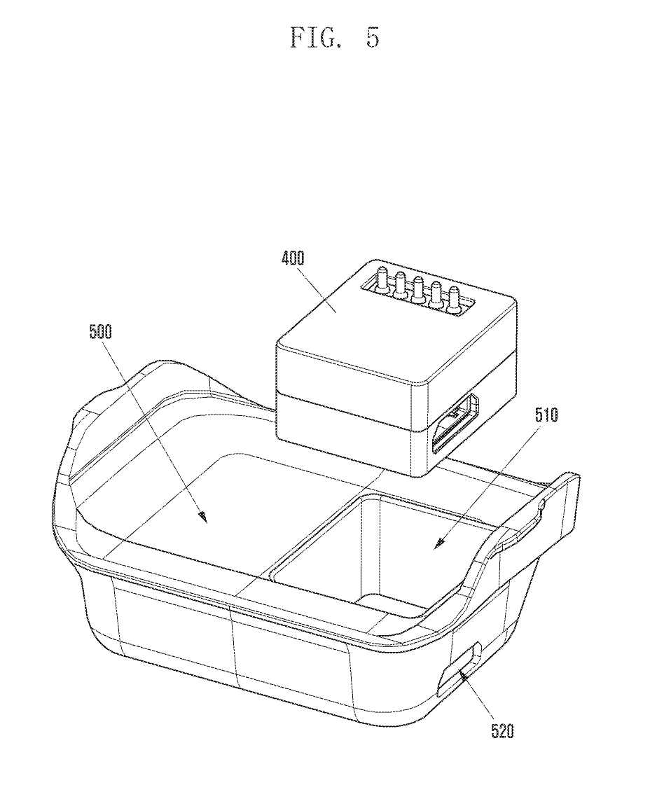

FIG. 5 is an exploded perspective view illustrating an assembly-type charging apparatus according to various embodiments of the present disclosure.

Referring to FIG. 5, the assembly-type charging apparatus may include the charger module 400 and a cradle 500.

The shape of the cradle 500 may be formed to correspond to the shape of a wearable device to be mounted while the shape of the charger module 400 may be maintained regardless of the shape of the wearable device. In order to effectively charge the wearable device, the location of a charger module mounting part 510 may be varied in the cradle 500 such that pins of the charger module 400 can be disposed for an electrical connection with pins of the wearable device.

In one embodiment, the charger module mounting part 510 may be disposed at the right half of the cradle 500 to hold the charger module 400 as shown in FIG. 5.

The cradle 500 may include the charger module mounting part 510. The shape of the charger module mounting part 510 may be substantially identical to that of the charger module 400. The size of the charger module mounting part 510 may be determined suitably for an easy attachment or detachment of the charger module 400.

The location of the charger module mounting part 510 may be determined in the cradle 500, considering an electrical connection between the charger module 400 and the wearable device.

The charger module mounting part 510 may hold the charger module 400 mounted thereon. Using a hook, a tape, a screw, etc., the charger module mounting part 510 may mechanically hold the charger module 400.

The cradle 500 may have a third hole 520. The shape of the third hole 520 may be substantially identical to that of the second hole 420 of the charger module 400. The size of the third hole 520 may be determined suitably for an easy attachment or detachment of the power connector. The power connector may pass the cradle 500 through the third hole 520 and be directly connected to the charger module 400.

Meanwhile, the cradle 500 may be formed of synthetic resin, thermoplastic polymer (e.g., ABS or polycarbonate), ceramic, wood, metal (e.g., polished aluminum), metal alloy (e.g., based on steel, stainless steel, titanium or magnesium), or any other suitable material.

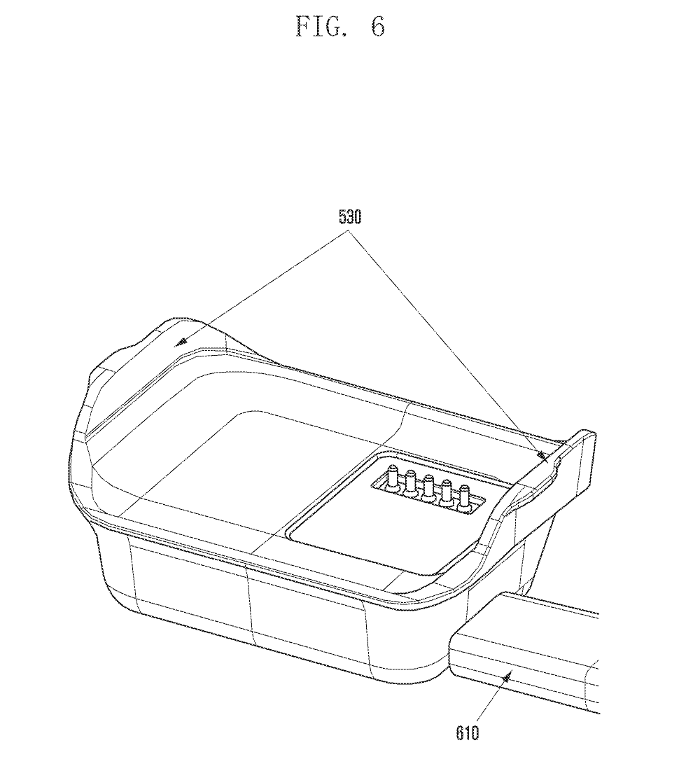

FIG. 6 is a perspective view illustrating an assembly-type charging apparatus according to various embodiments of the present disclosure.

FIG. 6 shows the charger module 400, the cradle 500, and a power connector 610.

The assembly-type charging apparatus may hold a wearable device mounted on the cradle 500, allowing the wearable device to be electrically connected to the charger module 400. In order to prevent the detachment of the wearable device, the assembly-type charging apparatus may include a protruding part 530 formed at both lateral edges of the cradle 500.

The protruding part 530 may have a hook or the like for mechanically binding the wearable device. Alternatively, the protruding part 530 may merely operate, without using a hook, as a supporting bracket for preventing the detachment of the wearable device.

The power connector 610 may pass through the third hole 520 of the cradle 500 and the second hole 420 of the charger module 400 and then be connected to the external power connecting terminal 334 of the charger module 400 so as to supply electric power from any external power source.

The shape of an end part of the power connector 610 may correspond to that of the external power connecting terminal 334 of the charger module 400 such that an electrical connection can be easily and reliably made.

In one embodiment, the power connector 610 may have a USB form. Thus, the external power connecting terminal 334 may have a USB-type socket to receive electric power from the USB-type power connector 610.

In another embodiment, the power connector 610 may be configured to have an integrated cable form. Thus, the external power connecting terminal 334 may have a structure corresponding to the integrated cable form to receive electric power from the cable-type power connector 610.

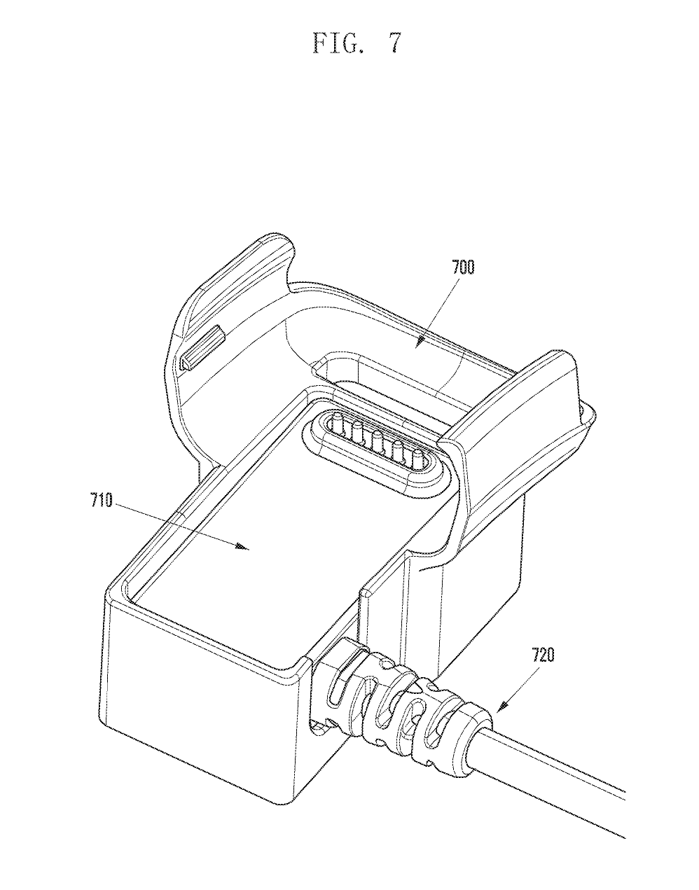

FIG. 7 is a perspective view illustrating an assembly-type charging apparatus according to various embodiments of the present disclosure.

Referring to FIG. 7, the assembly-type charging apparatus may include a cradle 700, a charger module 710, and a power connector 720.

The assembly-type charging apparatus may hold a wearable device mounted on the cradle 700, allowing the wearable device to be electrically connected to the charger module 710. In order to prevent the detachment of the wearable device, the assembly-type charging apparatus may include a protruding part formed at both lateral edges of the cradle 700.

The protruding part may have a hook or the like for mechanically binding the wearable device. Alternatively, the protruding part may merely operate, without using a hook, as a supporting bracket for preventing the detachment of the wearable device.

The cradle 700 may be different in appearance from the above-discussed cradle 500. Namely, in order to accommodate different-type wearable devices, the cradle 700 may have a charger module mounting part disposed at the middle portion thereof and holding the charger module 710.

The charger module 710 may have a substantially cubic shape with round edges. Meanwhile, the charger module 710 may be formed of synthetic resin, thermoplastic polymer (e.g., ABS or polycarbonate), ceramic, wood, metal (e.g., polished aluminum), metal alloy (e.g., based on steel, stainless steel, titanium or magnesium), or any other suitable material.

The combination of the first and second housings forms the internal space of the charger module 710. In this space, the PCB, the charging terminal, the external power connecting terminal, and the like can be disposed and mounted.

Referring to FIG. 7, the charger module 710 may be connected with the cable-type power connector 720. Contrary to a USB type, the cable-type power connector 720 may disallow the detachment from the charger module 710 and maintain a continuous connection therebetween.

Meanwhile, although having different-type power connector, the charger module 400 and the charger module 710 may have the substantially same shape and the substantially same charging terminal Additionally, although having different shapes depending on the shape of a wearable device to be mounted, the cradle 500 and the cradle 700 may share the charger modules 400 and 710 having the substantially same shape.

Therefore, in case the wearable device is changed, it is only required to use the cradle suitable for the changed wearable device to perform a charging function without the need to purchase other charger module adapted to the wearable device. Namely, since charging the wearable device is allowed by using a common charger module and changing only the cradle, a consumer's burden of cost may be reduced.

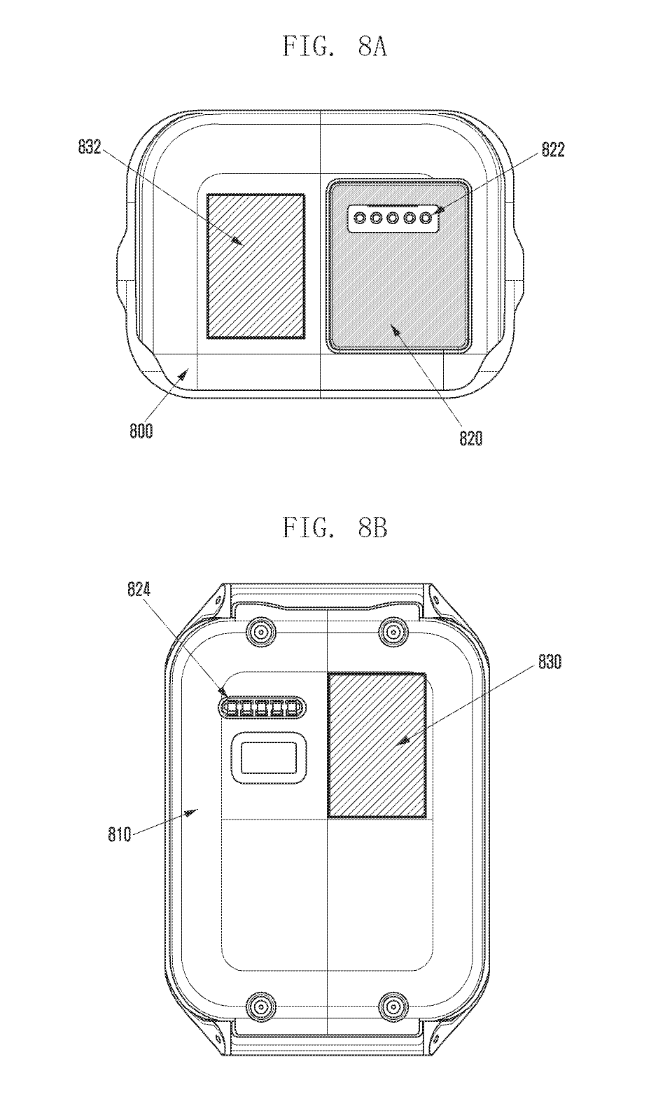

FIGS. 8A and 8B are plan views illustrating the disposition of magnetic members in an assembly-type charging apparatus and a wearable device according to various embodiments of the present disclosure.

FIGS. 8A and 8B show an assembly-type charging apparatus and a wearable device 810. The assembly-type charging apparatus may include a cradle 800, a charger module 820, a magnetic member 832, and a protruding part. The wearable device 810 may include a charging pin 824 and a magnetic member 830.

In one embodiment, the protruding part of the cradle 800 may form a supporting bracket rather than a hook or the like for binding the wearable device. In this case, it is possible to prevent a scratch of the wearable device 810 and also prevent breakage of the protruding part. However, if the protruding part of the cradle 800 has no binding means such as a hook, the wearable device 810 may fail to be mounted stably on the cradle 800. Therefore, when there is any external shock, the charging pin 824 of the wearable device 810 may be out of contact with a charging terminal 822 of the charger module 820 due to the movement of the wearable device 810. Unfortunately, this may invite an unstable supply of electric power to the wearable device 810.

In order to more stably mount the wearable device 810 on the assembly-type charging apparatus, the magnetic member 832 may be attached to the cradle 800. Alternatively or additionally, for the same reason, such a magnetic member may be attached to the charger module 820 or the charging terminal 822.

The magnetic member 832 may be exposed to the outside of the cradle 800 or embedded in the cradle 800.

Similarly, the wearable device 810 may have a metallic plate or the magnetic member 830 embedded therein for a stable combination with the magnetic member 832 of the assembly-type charging apparatus.

In case of embedding the metallic plate in the wearable device, a sufficient attractive force is required for a stable combination with the magnetic member 832. For this reason, the metallic plate needs to have a sufficient thickness or area in the wearable device. This may, however, hinder a reduction in size of the wearable device.

In case of embedding the magnetic member 830 in the wearable device, a sufficient attractive force is required for a stable combination with the magnetic member 832. Since an attractive force between the magnetic members is greater than that between the magnetic member and the metallic plate, using the magnetic member may be more effective for reducing the size of the wearable device than using the metallic plate.

In one embodiment, viewing down the assembly-type charging apparatus, the magnetic member 832 may be disposed at the left half of the cradle 800. Also, the charger module 820 may be disposed at the right half of the cradle 800.

Meanwhile, the charging pin 824 and the magnetic member 830 of the wearable device 810 may be disposed to correspond to the charger module 820 and the magnetic member 832 of the assembly-type charging apparatus.

In one embodiment, viewing down the rear side of the wearable device 810, the charging pin 824 corresponding to the charging terminal 822 of the charger module 820 may be disposed at the top left-hand portion of the wearable device 810. Also, the magnetic member 830 corresponding to the magnetic member 832 of the assembly-type charging apparatus may be disposed at the top right-hand portion of the wearable device 810. This disposition may allow the wearable device to be more stably mounted on the assembly-type charging apparatus and to be stably charged with electric power.

The above discussion is exemplary only and not to be construed as a limitation of the present disclosure. For example, type, disposition, number, etc. of the magnetic member may be varied by manufacturers.

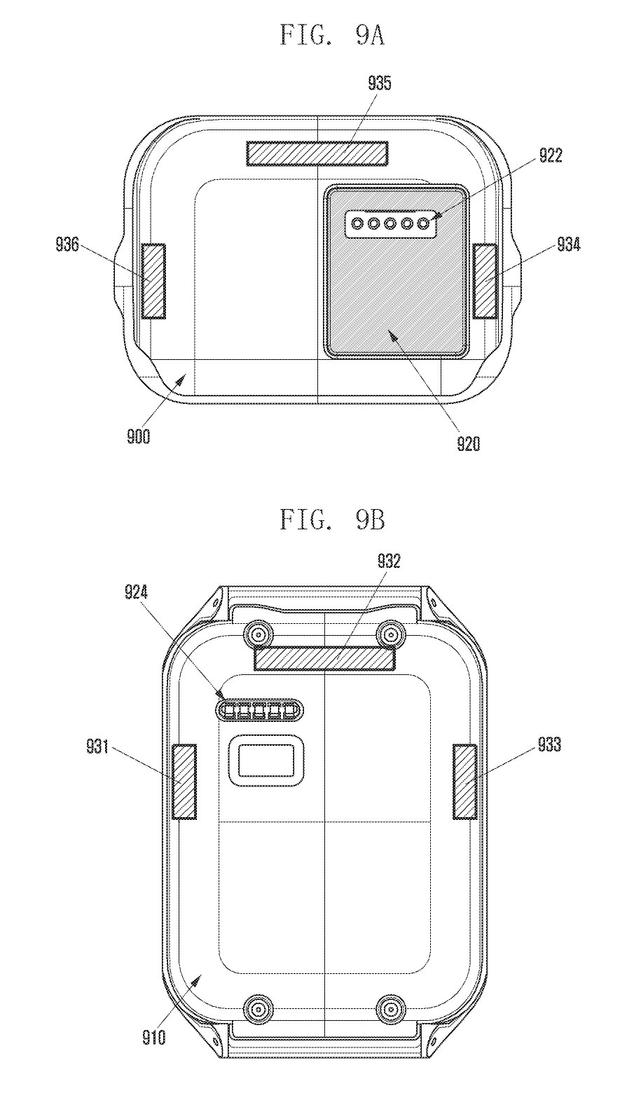

FIGS. 9A and 9B are plan views illustrating the disposition of magnetic members in an assembly-type charging apparatus and a wearable device according to various embodiments of the present disclosure.

FIGS. 9A and 9B show an assembly-type charging apparatus and a wearable device 910. The assembly-type charging apparatus may include a cradle 900, a charger module 920, magnetic members 934, 935 and 936, and a protruding part. The wearable device 910 may include a charging pin 924 and magnetic members 931, 932 and 933.

In one embodiment, the protruding part of the cradle 900 may form a supporting bracket rather than a hook or the like for binding the wearable device. In this case, it is possible to prevent a scratch of the wearable device 910 and also prevent breakage of the protruding part. However, if the protruding part of the cradle 900 has no binding means such as a hook, the wearable device 910 may fail to be mounted stably on the cradle 900. Therefore, when there is any external shock, the charging pin 924 of the wearable device 910 may be out of contact with a charging terminal 922 of the charger module 920 due to the movement of the wearable device 910. Unfortunately, this may invite an unstable supply of electric power to the wearable device 910.

In order to more stably mount the wearable device 910 on the assembly-type charging apparatus, the magnetic members 934, 935 and 936 may be attached to the cradle 900. Alternatively or additionally, for the same reason, such a magnetic member may be attached to the charger module 920 or the charging terminal 922.

The magnetic members 934, 935 and 936 may be exposed to the outside of the cradle 900 or embedded in the cradle 900.

Similarly, the wearable device 910 may have a metallic plate or the magnetic members 931, 932 and 933 embedded therein for a stable combination with the magnetic members 934, 935 and 936 of the assembly-type charging apparatus.

In case of embedding the metallic plate in the wearable device, a sufficient attractive force is required for a stable combination with the magnetic members 934, 935 and 936. For this reason, the metallic plate needs to have a sufficient thickness or area in the wearable device. This may, however, hinder a reduction in size of the wearable device.

In case of embedding the magnetic members 931, 932 and 933 in the wearable device, a sufficient attractive force is required for a stable combination with the magnetic members 934, 935 and 936. Since an attractive force between the magnetic members is greater than that between the magnetic member and the metallic plate, using the magnetic member may be more effective for reducing the size of the wearable device than using the metallic plate.

In one embodiment, viewing down the assembly-type charging apparatus, the magnetic members 934, 935 and 936 may be disposed respectively near the right, top and left edges of the cradle 900. Also, the charger module 920 may be disposed at the right half of the cradle 900 so as not to be overlapped with the magnetic members 934, 935 and 936.

Meanwhile, the charging pin 924 and the magnetic members 931, 932 and 933 of the wearable device 910 may be disposed to respectively correspond to the charger module 920 and the magnetic members 934, 935 and 936 of the assembly-type charging apparatus.

In one embodiment, viewing down the rear side of the wearable device 910, the charging pin 924 corresponding to the charging terminal 922 of the charger module 920 may be disposed at the top left-hand portion of the wearable device 910. Also, the magnetic members 931, 932 and 933 corresponding to the magnetic members 934, 935 and 936 of the assembly-type charging apparatus may be disposed respectively near the left, top and right edges of the wearable device 910. This disposition may allow the wearable device to be more stably mounted on the assembly-type charging apparatus and to be stably charged with electric power.

The above discussion is exemplary only and not to be construed as a limitation of the present disclosure. For example, type, disposition, number, etc. of the magnetic member may be varied by manufacturers.

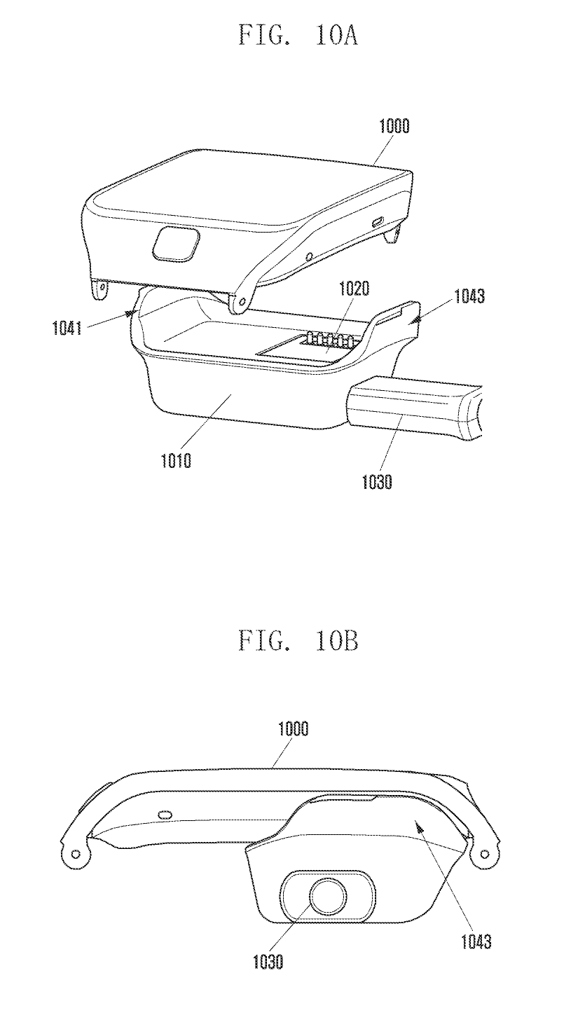

FIGS. 10A and 10B are views illustrating a process of combining a wearable device with an assembly-type charging apparatus according to various embodiments of the present disclosure.

FIGS. 10A and 10B show an assembly-type charging apparatus and a wearable device 1000. The assembly-type charging apparatus may include a cradle 1010, a charger module 1020, a power connector 1030, and protruding parts 1041 and 1043.

When the wearable device 1000 is mounted on the cradle 1010, a charging terminal of the charger module 1020 keeps in contact with a charging pin formed on the rear side of the wearable device 1000 so as to perform a charging function.

In one embodiment, a magnetic member of the cradle 1010 is combined with that of the wearable device 1000 by means of an attractive force, so that the wearable device 100 can be stably mounted on the assembly-type charging apparatus. In this case, the protruding parts 1041 and 1043 may act as a supporting bracket for preventing a change in position of the wearable device 1000.

According to various embodiments, a charging apparatus may include a cradle having a space for holding an electronic device and also having at least one magnetic member for providing a magnetic connection with the electronic device, and a charger module connected with the cradle and supplying electric power to the electronic device.

The electronic device may be a wearable device.

The cradle may further have a protruding part formed at both lateral edges thereof, and the protruding part may be configured to support both lateral sides of the electronic device.

The cradle may further have a charger module mounting part configured to receive therein and hold the charger module.

The cradle may further have a hole located near the charger module mounting part and configured to pass a power connector having a USB form.

The cradle may further have an open passage located near the charger module mounting part and configured to pass a power connector having a cable form.

The charger module may include a first housing, a second housing, a charging terminal, and an external power connecting terminal.

The first housing may have a first hole which the charging terminal is partially inserted into and pins thereof pass through.

The second housing may have a second hole which the external power connecting terminal is partially inserted into and pins thereof are exposed to.

The charging terminal may have at least one protruding pin configured to be electrically connected with a charging pin of the electronic device.

The external power connecting terminal may be configured to be connected with a power connector having a USB form.

The charger module may further include a power connector having a cable form, and the external power connecting terminal is connected with the power connector.

The magnetic member may be disposed near the charger module mounting part.

The magnetic member may be disposed near at least one edge of the cradle.

The magnetic member may be attached to the cradle to be exposed to the outside of the cradle.

The magnetic member may be embedded in the cradle.

The magnetic member may be attached to the protruding part.

According various embodiments, a cradle may include a space for holding an electronic device, and at least one magnetic member for providing a magnetic connection with the electronic device.

The cradle may further include a protruding part formed at both lateral edges thereof, wherein the protruding part is configured to support both lateral sides of the electronic device.

The cradle may further include a charger module mounting part configured to receive therein and hold the charger module.

According to various embodiments of the present disclosure, a charging apparatus can easily and effectively charge a wearable device.

While the present disclosure has been shown and described with reference to various embodiments thereof, it will be understood by those skilled in the art that various changes in form and details may be made therein without departing from the spirit and scope of the present disclosure as defined by the appended claims and their equivalents.

What is claimed is:

1. A charging apparatus comprising:
a cradle including a space for holding an electronic device, and including at least one magnetic member for providing a magnetic connection with the electronic device; and
a charger module connected with the cradle and supplying electric power to the electronic device.

2. The charging apparatus of claim 1, wherein the electronic device is a wearable device.

3. The charging apparatus of claim 1, wherein the cradle further includes a protruding part formed at both lateral edges thereof, and the protruding part is configured to support both lateral sides of the electronic device.

4. The charging apparatus of claim 1, wherein the cradle further includes a charger module mounting part configured to receive and hold the charger module therein.

5. The charging apparatus of claim 4, wherein the cradle further includes a hole located near the charger module mounting part and is configured to pass a power connector having a Universal Serial Bus (USB) form.

6. The charging apparatus of claim 4, wherein the cradle further includes an open passage located adjacent to the charger module mounting part and is configured to pass a power connector having a cable form.

7. The charging apparatus of claim 1, wherein the charger module includes a first housing, a second housing, a charging terminal, and an external power connecting terminal.

8. The charging apparatus of claim 7, wherein the first housing includes a first hole which the charging terminal is partially inserted into and pins thereof pass through.

9. The charging apparatus of claim 7, wherein the second housing includes a second hole which the external power connecting terminal is partially inserted into and pins thereof are exposed to.

10. The charging apparatus of claim 7, wherein the charging terminal includes at least one protruding pin configured to be electrically connected with a charging pin of the electronic device.

11. The charging apparatus of claim 7, wherein the external power connecting terminal is configured to be connected with a power connector having a Universal Serial Bus (USB) form.

12. The charging apparatus of claim 7, wherein the charger module further includes a power connector having a cable form, and the external power connecting terminal is connected with the power connector.

13. The charging apparatus of claim 4, wherein the magnetic member is disposed adjacent to the charger module mounting part.

14. The charging apparatus of claim 1, wherein the magnetic member is disposed adjacent to at least one edge of the cradle.

15. The charging apparatus of claim 1, wherein the magnetic member is attached to the cradle to be exposed to outside of the cradle.

16. The charging apparatus of claim 1, wherein the magnetic member is embedded in the cradle.

17. The charging apparatus of claim 3, wherein the magnetic member is attached to the protruding part.

18. A cradle comprising:
a space for holding an electronic device; and
at least one magnetic member for providing a magnetic connection with the electronic device.

19. The cradle of claim 18, further comprising:
a protruding part formed at both lateral edges thereof, wherein the protruding part is configured to support both lateral sides of the electronic device.

20. The cradle of claim 18, further comprising:
a charger module mounting part configured to receive and hold the charger module therein.
